(19) United States
(12) Patent Application Publication
(10) Pub. No.: US 2015/0217786 A1
(43) Pub. Date: Aug. 6, 2015

(54) EXIT SYSTEM, IN PARTICULAR EMERGENCY EXIT SYSTEM, FOR A RAIL VEHICLE

(71) Applicant: SIEMENS AKTIENGESELLSCHAFT, Muenchen (DE)

(72) Inventor: Martin Krause, Krefeld (DE)

(21) Appl. No.: 14/382,355

(22) PCT Filed: Feb. 5, 2013
(86) PCT No.: PCT/EP2013/052191

§ 371 Date: Sep. 2, 2014

(30) Foreign Application Priority Data
Mar. 1, 2012 (DE) 10 2012 203 248.7

(51) Int. Cl. B61D 19/02; E06C 5/02

(52) U.S. Cl. CPC B61D 19/023; E06C 5/02

(57) ABSTRACT

An exit system, in particular an emergency exit system, for a rail vehicle has a fixture device and a ladder-like exit and/or descent aid that is removably fastened to the fixture device for exiting and descending from an exit opening leading from the interior of the rail vehicle to the vehicle exterior. Accordingly, the fixture device and the exit and/or descent aid fastened to the fixture device are formed from an interior furnishing object of the rail vehicle. Wherein an element of the interior furnishing object that is removably fastened to the rest of the interior furnishing object forms the exit and/or descent aid. The rest of the interior furnishing object forms the fixture device, and the element fastened to the rest of the interior furnishing object is functionally integrated into the interior furnishing object.

The invention relates to an exit system, in particular an emergency exit system, for a rail vehicle, with a fixture device and a ladder-like exit and/or descent aid which is fastened releasably to the fixture device and is intended for the exiting and descending from an exit opening leading from the interior of the rail vehicle to the vehicle exterior.

In rail vehicles, exit and/or descent aids, such as, for example, rope ladders or rescue ladders, etc., are carried along in order, in the event of a fire or a similar emergency situation, to enable vehicle occupants to be evacuated from the vehicle interior of the rail vehicle. Exit and/or descent aids of this type are always necessary whenever the corresponding exit opening is located about the rail top (RT) at a height which can even make the exit from the vehicle through said exit opening hazardous without a suitable exit and/or descent aid for the vehicle occupants. The carrying of exit and/or descent aids of this type is the rule in Germany/Europe above a distance between the rail top and the lower edge of the exit opening of one meter and eighty centimeters (1.8 m). For such an exit and/or descent aid, storage space which is also indicated as storage space for said exit and/or descent aid has to be kept ready in the rail vehicle. If said storage space is away from the customary interior furnishing, the access path to said exit and/or descent aid has to be clearly indicated.

It is the object of the present invention to indicate a simple and space-saving exit system. The object is achieved by the features of independent claim 1. Advantageous refinements are indicated in the dependent claims.

In the case of the exit system according to the invention it is provided that the fixture device and the exit and/or descent aid, which is fastened to the fixture device, are formed by an interior furnishing object of the rail vehicle. In this case, an element of the interior furnishing object, which element is fastened so as to be releasable from the rest of the interior furnishing object, forms the exit and/or descent aid, and the rest of the interior furnishing object forms the fixture device. The element which is fastened to the rest of the interior furnishing object is functionally integrated into the interior furnishing object. The exit system is, in particular, an emergency exit system. The rail vehicle is preferably a rail vehicle for conveying passengers (rail vehicle for transporting people).

An exit system of this type is space-saving, since the exit and/or descent aid is integrated into one of the interior furnishing objects. Furthermore, the advantage arises of it being possible to dispense with information regarding the access path to the exit and/or descent aid of the system, since the exit and/or descent aid as part of an interior furnishing object is a direct part of the interior furnishings.

The exit opening is, in particular, an emergency exit opening, for example a window or an exit hatch of the vehicle.

In particular, it is provided that the element which is fastened to the rest of the interior furnishing object has a function for the interior furnishing object. This is a type of functional integration of the element, which is fastened to the rest of the interior furnishing object, into the interior furnishing object.

Alternatively or in addition, it is advantageously provided that the element which is fastened to the rest of the interior furnishing object carries out, or at least assists, the function of the interior furnishing object or at least one function of the interior furnishing object. This is a further type of functional integration of the element, which is fastened to the rest of the interior furnishing object, into the interior furnishing object.

Advantageously, when the element is released, the rest of the interior furnishing object can completely, or at least to a limited extent, carry out the function of the interior furnishing object.

According to a preferred embodiment of the invention, it is provided that the interior furnishing object is designed as a luggage shelf or as a luggage rack.

According to a further preferred embodiment of the invention, it is provided that the element is designed as a releasable supporting part of the interior furnishing object designed as a luggage shelf or as a luggage rack. The supporting part is in particular an element of the luggage shelf or of the luggage rack, i.e., for example, a rack part of the luggage rack.

Alternatively, it is advantageously provided that the element is designed as a front covering of the interior furnishing object designed as a luggage shelf.

According to a preferred refinement of the invention, it is provided that the fastening is a fastening for the tool-free release of the element from the rest of the fastening element. For this purpose, a corresponding fastening system is provided.

According to a further preferred embodiment of the invention, the system furthermore has at least one information element indicating the exit and/or descent aid. Said information element is, in particular, an information sign.

Furthermore, according to yet another preferred embodiment of the invention, the system has at least one exit opening and at least one further information element indicating said exit opening. Said further information element is also, in particular, an information sign.

Exemplary embodiments of the invention are explained in more detail below with reference to drawings, in which

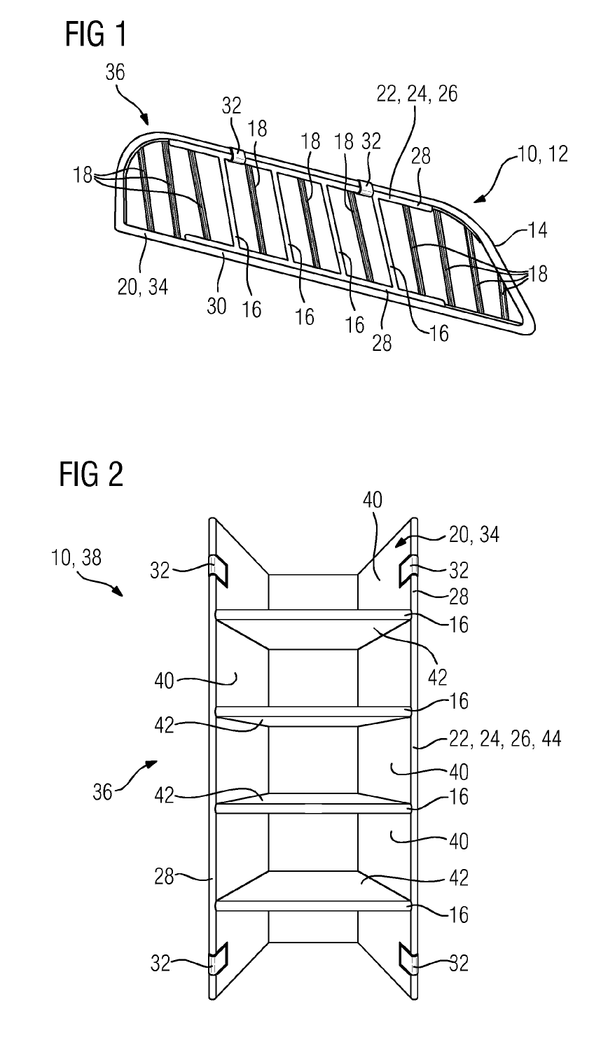

FIG. 1 shows an exit system with a ladder-like exit and/or descent aid which is formed by an element of an interior furnishing object of the vehicle, and

FIG. 2 shows an exit system with a ladder-like exit and/or descent aid which is formed by an element of another interior furnishing object of the vehicle.

FIG. 1 shows an interior furnishing object 10 from the interior of a rail vehicle. Said interior furnishing object 10 is designed as a luggage rack 12. Luggage racks 12 of this type are used, for example, in passenger trains, i.e. rail vehicles for transporting people. A luggage rack 12, as depicted, is located, for example, above the seats in the compartment of a compartment coach and is fastened there to a corresponding compartment wall. Said interior furnishing object 10 designed as a luggage rack 12 comprises a frame 14 and struts 16, 18 running parallel to one another in the frame 14. The frame 14, for its part, has fastening elements for the fastening to the compartment wall (not shown). The interior furnishing object 10 here has an element 22 of the interior furnishing object 10, which element is fastened so as to be releasable from the rest 20 of the interior furnishing object 10 and forms an exit and/or descent aid 24. The exit and/or descent aid 24 is an exit and/or descent aid 24 for the exiting and descending from an exit opening leading from the interior of the rail vehicle to the vehicle exterior. Specifically, said exit and/or descent aid 24 is designed as a ladder 26. The rungs of the ladder 26 are formed by some of the struts 16, and the uprights of the ladder 26 are formed by frame parts 28 of the frame 14. The rest 20 of the interior furnishing object consists of the rest of the struts 18 and of a basic frame part 30 which, together with the frame parts 28, forms the frame 14 of the luggage rack. One of the frame parts 28 is insertable/inserted into a corresponding recess in the basic frame part 30 and the element 22 can subsequently be pivoted into the rest such that the other of the frame parts 28 can be fastened on the opposite side of the basic frame part 30.

For this purpose, the element 22 is fastened releasably to the rest 20 of the interior furnishing object by means of a fastening system 32. Said fastening system 32 is based, for example, on one or more split pin elements. The latter are preferably provided with seals, security seals, etc. The fastening of the element 22 to the rest 20 of the furnishing object is a fastening for the tool-free release of the element 22 from the rest 20 of the fastening element 10. The element 22 of the interior furnishing object 10 of FIG. 1 is therefore a supporting part of the luggage rack 12.

The function of the luggage rack 12 is to retain and support passenger luggage. That is to say, the element 22 which is fastened to the rest 20 of the interior furnishing object, namely the supporting part, therefore assists the function of the interior furnishing object designed as a luggage rack.

If the interior furnishing object 10 is then considered in its function with respect to the exit from the rail vehicle, one element 22 of the interior furnishing object 10 forms the exit and/or descent aid 24 and the rest 20 of the interior furnishing object 10 forms a fixture device (a holder) 34 of said exit and/or descent aid 24. In other words, these two elements (exit and/or descent aid 24 and fixture device 34) are parts of an exit system 36, in more precise terms of an emergency exit system.

Said exit system 36 furthermore comprises a corresponding exit opening (not shown). The latter is designed, for example, as an exit hatch. If an emergency exit system is involved, the exit opening is, for example, a window or an emergency exit hatch. Furthermore, said system 36 preferably also comprises at least one information element indicating the exit and/or descent aid 24, and at least one further information element indicating the exit opening. Said information elements are, for example, information signs.

The exit and/or descent aid 24 has an overall length which permits safe descent from the exit opening. The exit and/or descent aid 24 preferably has an overall length of at least 1.8 meters, particularly preferably of more than 2.2 meters.

FIG. 2 likewise shows an interior furnishing object 10 from the interior of a rail vehicle. This interior furnishing object 10 is designed as a luggage shelf 38. Luggage shelves 38 of this type are likewise used in passenger trains, i.e. rail vehicles for transporting people. A luggage shelf 38, as depicted in FIG. 2, is located, for example, in a saloon coach and is fastened there to corresponding walls or covering elements. Said interior furnishing object 10 designed as a luggage shelf 38 comprises shelf walls 40, shelf bases 42 and a ladder-shaped front covering 44. The latter is fastened releasably to the rest 40, 42 of the luggage shelf, i.e. to the rest 20 of the interior furnishing object. The front covering 44 covers the “bare” rest 20. In this case, struts 16 of the ladder-shaped front covering 44 cover the shelf bases 42 and frame parts 28 of the front covering cover the shelf walls 40. The element 22, namely the front covering 44, which is fastened to the rest 20 of the interior furnishing object therefore has a function for the interior furnishing object 10. The rungs of the ladder 26 are therefore also formed here by the struts 16 and the uprights of the ladder 26 are formed by the frame parts 28 of the front covering 44.

The element 22 designed as the front covering 44 is also fastened releasably in this embodiment to the rest of the interior furnishing object 10 by means of the fastening system 32. Said fastening system 32 is based on tabs which engage around the upright structures of the front covering 44 and are fixed to the walls 40 by means of a plurality of split pin elements of the system 32. The split pin elements are also preferably provided here with seals, security seals etc. The fastening of the element 22 to the rest 20 of the furnishing object is also, in this example, a fastening for the tool-free release of the element 22 from the rest 20 of the fastening element 10.

If the interior furnishing object 10, which is designed as a luggage shelf 38, is also considered here in its function with respect to the exit from the rail vehicle, one element 22, namely the front covering 44, of the interior furnishing object 10 forms the exit and/or descent aid 24 and the rest 20 of the interior furnishing object 10 (of the luggage shelf 38) forms a fixture device 34 of said exit and/or descent aid 24. In other words, said two elements (exit and/or descent aid 24 and fixture device 34) are parts of an exit system 36, in more precise terms of an emergency exit system. Specifically, the exit and/or descent aid 24 is also designed here as a ladder 26 with uprights and rungs.

1-10. (canceled)

11. An exit system for a rail vehicle, comprising:
a fixture device;
a ladder-shaped exit and/or descent aid fastened releasably to said fixture device and intended for exiting and descending from an exit opening leading from an interior of the rail vehicle to a vehicle exterior; and
said fixture device and said ladder-shaped exit and/or descent aid are formed by an interior furnishing object of the rail vehicle, said interior furnishing object having an element fastened so as to be releasable from a rest of said interior furnishing object and forming said ladder-shaped exit and/or descent aid, said rest of said interior furnishing object forming said fixture device, said element fastened to said rest of said interior furnishing object being functionally integrated into said interior furnishing object.

12. The exit system according to claim 11, wherein said element which is fastened to said rest of said interior furnishing object has a function for said interior furnishing object.

13. The exit system according to claim 11, wherein said element which is fastened to said rest of said interior furnishing object carries out, or at least assists, a function of said interior furnishing object or at least one of a plurality of functions of said interior furnishing object.

14. The exit system according to claim 13, wherein when said element is released, said rest of said interior furnishing object can fully, or at least to a limited extent, carry out the function of said interior furnishing object.

15. The exit system according to claim 11, wherein said interior furnishing object is a luggage shelf or as a luggage rack.

16. The exit system according to claim 15, wherein said element is a releasable supporting part of said interior furnishing object configured as said luggage shelf or as said luggage rack.

17. The exit system according to claim 15, wherein said element is a front covering of said interior furnishing object configured as said luggage shelf.

18. The exit system according to claim 11, further comprising a fastener for a tool-free release of said element from said rest of said interior furnishing object.

19. The exit system according to claim 11, further comprising at least one information element indicating said ladder-shaped exit and/or descent aid.

20. The exit system according to claim 19, further comprising at least one further information element indicating the exit opening.

21. The exit system according to claim 11, wherein the exit system is an emergency exit system.

22. The exit system according to claim 19, wherein said at least one information element is an information sign.
